(19) United States
(12) Patent Application Publication
(10) Pub. No.: US 2007/0127871 A1
(43) Pub. Date: Jun. 7, 2007

(54) Boot for MT connector

(75) Inventors: Yoshinori Kurosawa, Hitachi (JP); Kazuya Murakami, Hitachi (JP); Yoshihiro Kodaka, Kitaibaraki (JP); Yoshihiro Nakatani, Hitachi (JP); Takahiro Sato, Hitachi (JP)

Correspondence Address: FOLEY AND LARDNER LLP;SUITE 500, 3000 K STREET NW, WASHINGTON, DC, 20007, US

(73) Assignee: HITACHI CABLE, LTD.

(21) Appl. No.: 11/292,279

(22) Filed: Dec. 2, 2005

(51) Int. Cl. G02B 6/38

(52) U.S. Cl. 385/69; 385/53; 385/54; 385/55; 385/56; 385/59; 385/60

(57) ABSTRACT

A boot for an MT connector used for installing a multicore optical fiber tape unit into the MT connector. The boot has a taper part that converts an array pitch in a plurality of optical fiber cores bundled in the optical fiber tape unit.

The present application is based on Japanese Patent Application No. 2004-166570 filed on Jun. 4, 2004, the entire contents of which are incorporated herein by reference.

### BACKGROUND OF THE INVENTION

1. Field of the Invention

This invention relates to a boot for an MT connector used in connecting a multicore optical fiber tape unit such as a 4-core, 8-core and 12-core optical fiber tape unit and, more particularly, to a boot for an MT connector that allows the installation of an optical fiber tape unit with optical fiber cores which have an increased diameter and a core pitch of 0.25 mm or more into a conventional MT connector with a core pitch of 0.25 mm.

2. Description of the Related Art

Various connectors are used for optical fiber connection, as FTTH (Fiber To The Home) spreads domestically in recent years.

Of the various connectors, MT connectors are used to connect a 4-core or 8-core optical fiber tape unit in the main line or access line of an optical fiber network.

FIG. 1 shows a structure of a 4-core MT connector.

The MT connector 51 comprises optical fibers 52 prefixed therein, and two joint pins 53 for easily realizing low-loss coupling.

A boot 55 for the MT connector which is made of rubber and has a larger cross section than that of an optical fiber tape unit 54 is provided at a pull-out part of the optical fiber tape unit 54 so as to prevent disconnection of the optical fiber when being bent. Since the optical fiber core of the optical fiber tape unit 54 has a coating diameter of about 250 μm, the array pitch of the optical fiber cores at the end of the connector is set to be 250 μm except a special case.

The related art of the invention is, for example, JP-A-9-197194 and JP-A-9-304658.

Conventional MT connectors are designed for an optical fiber tape unit having optical fiber cores with an outside diameter of 250 μm (=0.25 mm), which is the international standard.

On the other hand, an optical fiber tape unit having optical fiber cores with an outside diameter of 0.4 mm or more has been proposed to enhance the handling property.

FIG. 6 shows a structure of the proposed optical fiber tape unit (with 4 cores) and the optical fiber core.

The optical fiber core 61 comprises; an optical fiber glass part 62 with an outside diameter of about 0.125 mm; an ultraviolet curing resin coating layer 63 which covers the optical fiber glass part 62 in cylindrical shape to have an outside diameter of about 0.245 mm; a colored layer 64 which comprises first and second coating layers 63A, 63B and covers the resin coating layer 63 to have an outside diameter of about 0.255 mm; and an ultraviolet curing resin overcoat layer 65 which covers the colored layer 64 to have a final outside diameter of about 0.50 mm. The colored layer 64 as an intermediate layer can facilitate the identification thereof and the removal of the overcoat layer 65 at the end part.

The optical fiber tape unit 66 comprises four optical fiber cores bundled by an overall coating 67 of an ultraviolet curing resin to have a minor diameter of 0.52 mm and a major diameter of 2.05 mm in the overall dimensions.

Since the above-mentioned optical fiber tape unit has a core pitch of 0.50 mm which corresponds to the final outside diameter of the optical fiber core 61, a problem will occur that it is impossible to install the optical fiber tape unit into the conventional standard MT connector with a pitch of 0.25 mm even when the overcoat layer 65 is removed.

### SUMMARY OF THE INVENTION

Accordingly, it is an object of the present invention to provide a boot for MT connector that allows the installation of the optical fiber tape unit having the optical fiber cores with the increased diameter into the conventional MT connector.

According to the invention, a boot for an MT connector used for installing a multicore optical fiber tape unit into the MT connector comprises:

a taper part that converts an array pitch in a plurality of optical fiber cores bundled in the optical fiber tape unit.

In the above invention, the following modifications and changes or a combination thereof can be made.

(i) The taper part comprises a configuration that converts the array pitch from 0.4 mm or more at an entrance of the taper part to 0.25 mm at an exit of the taper part.

(ii) The taper part has a length not less than the product of <the number of the optical fiber cores> and <an outside diameter of the optical fiber cores>.

(iii) The boot for the MT connector further comprising a parallel-walled section formed subsequent to the taper part, wherein the parallel-walled section has a length of 2 mm or more so as to allow alignment of the optical fiber cores.

### ADVANTAGES OF THE INVENTION

Since the boot for MT connector of this invention has the taper part to convert the array pitch (core pitch) of the optical fiber cores, the optical fiber tape unit having the optical fiber cores with an increased diameter can be installed into the conventional MT connector.

Further, even when the overcoat layer of the optical fiber tape unit is removed such that the optical fiber cores are separated into single cores, since they are accommodated in the boot for the MT connector, they can be reinforced such that they are hard to bend and they have sufficient damage resistance as compared to the case that they are simply bound.

Further, since the taper part has a length not less than the product of <the number of the optical fiber cores> and <the outside diameter of the optical fiber cores>, it is possible to reduce the bend loss due to the bend of the optical fiber core caused by conversion of the array pitch at the taper part.

Further, the optical fiber cores can be precisely aligned even after the conversion of the array pitch, since the boot has the parallel-walled section of a length of 2 mm or more subsequent to the taper part in the insertion direction of the optical fiber tape unit.

### BRIEF DESCRIPTION OF THE DRAWINGS

Next, preferred embodiment according to the invention will be explained in conjunction with appended drawings, wherein;

FIG. 1 is a perspective view showing the conventional MT connector;

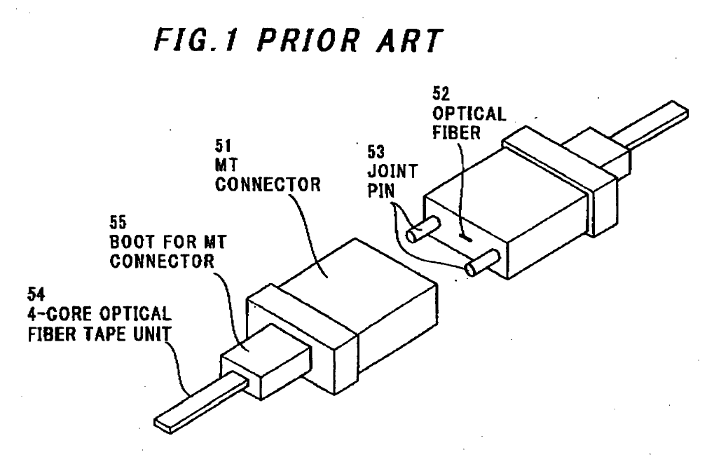

FIGS. 2A to 2E show a boot for MT connector in a preferred embodiment according to the invention, wherein FIG. 2A is a perspective view, FIG. 2B is a front view, FIG. 2C is a plan view, FIG. 2D is a left side view, and FIG. 2E is a right side view;

FIGS. 3A to 3E are explanatory diagrams showing an installation process of the optical fiber tape unit to the boot for MT connector according to the invention, wherein FIG. 3A shows a step of removing a coating layer of terminals, FIG. 3B shows a step of inserting optical fiber cores, FIG. 3C shows a step of completing the insertion of the optical fiber core, FIG. 3D shows a step of removing a coating layer of the optical fiber cores, and FIG. 3E shows a step of inserting the boot for MT connector in the MT connector;

FIG. 4 is an explanatory diagram showing the state of the array pitch conversion at the taper part of the boot for MT connector according to the invention;

FIG. 5 is a graph showing a relation between a length of the taper part and the bend loss; and

FIG. 6 is a diagram showing the optical fiber core having an increased diameter and the optical fiber tape unit.

### DETAILED DESCRIPTION OF THE PREFERRED EMBODIMENT

A boot for MT connector in the preferred embodiment according to the invention will be described below in regard to the appended drawings.

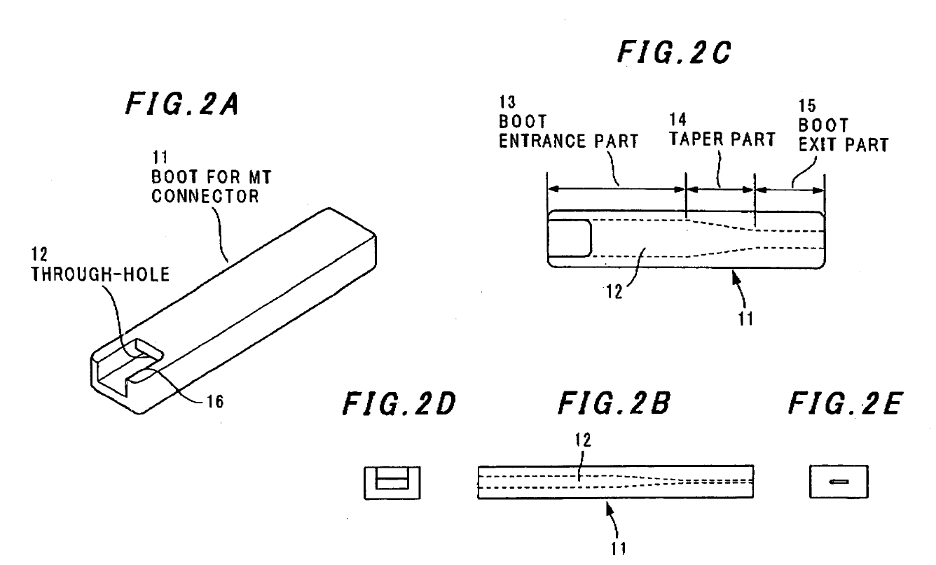

FIG. 2 shows a boot for a MT connector in the embodiment according to the invention.

A boot 11 for a MT connector formed substantially rectangular comprises a through-hole 12 to which an optical fiber tape unit 26 is inserted. The through-hole 12 comprises, along the longitudinal direction, a boot entrance part 13 to which the optical fiber tape unit 26 having plural optical fiber cores 21 with an increased diameter is inserted, a taper part 14 in which the diameter of the through-hole 12 is reduced along the longitudinal direction, and a boot exit part 15 which allows the alignment of the optical fiber cores 21, which are converted in array pitch and from which an overall coating 27 is removed. A notch 16 is provided at the upper surface of an insertion side of the boot 11 to facilitate the insertion of the optical fiber tape unit 26 and to confirm the alignment of the cores.

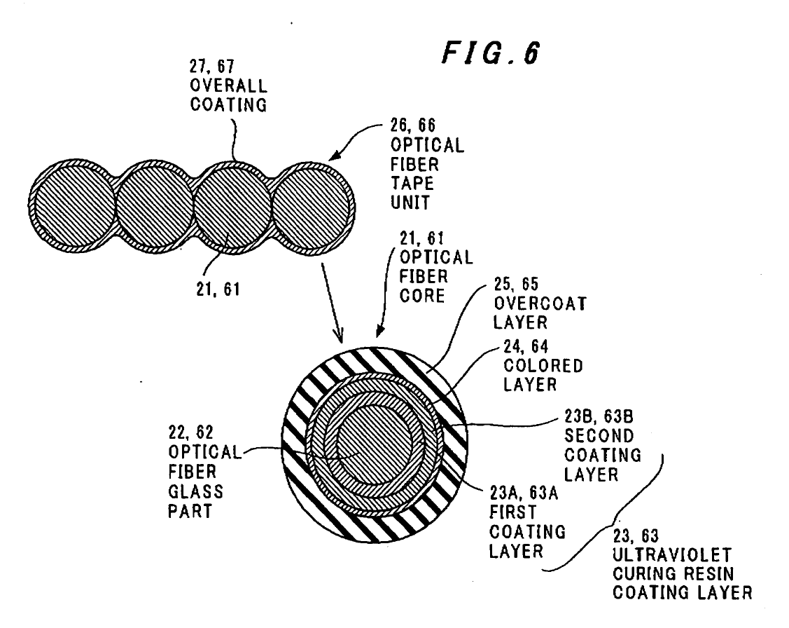

Again referring to FIG. 6, the optical fiber tape unit 26 comprises the four optical fiber cores 21 bundled by the overall coating 27 of an ultraviolet curing resin. The optical fiber core 21 comprises: an optical fiber glass part 22 with an outside diameter of about 0.125 mm; an ultraviolet curing resin coating layer 23 which comprises first and second coating layers 23A, 23B and covers an optical fiber glass part 22 in cylindrical shape to have an outside diameter of about 0.245 mm; a colored layer 24 which covers the resin coating layer 23 to have an outside diameter of about 0.255 mm; and an ultraviolet curing resin overcoat layer 25 which covers the colored layer 24 to have a final outside diameter of about 0.50 mm. The colored layer 24 as an intermediate layer can facilitate the identification thereof and the removal of the overcoat layer 25 at the end part.

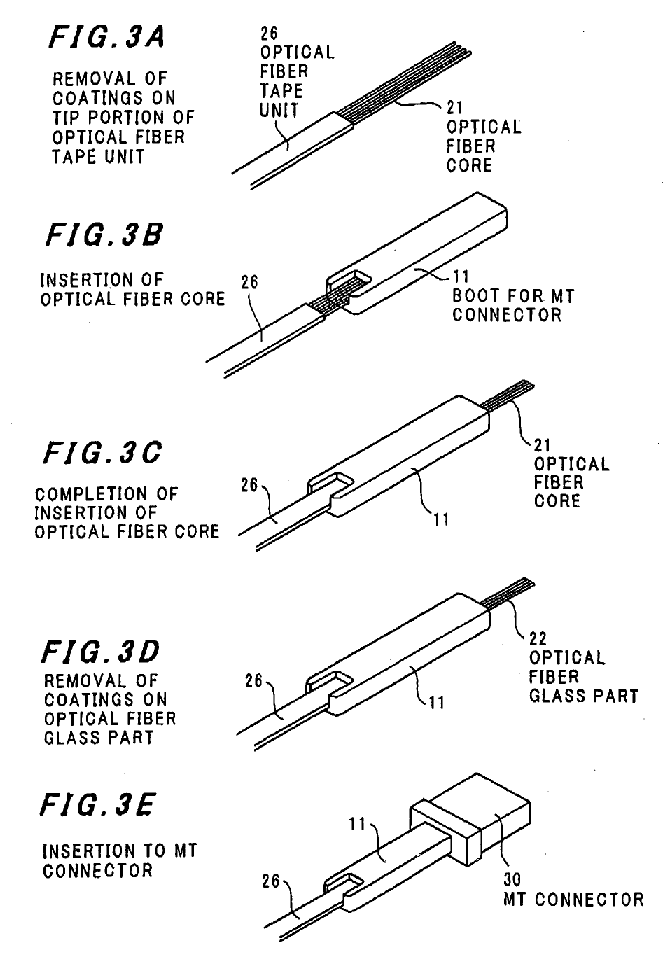

FIGS. 3A to 3E show a process of installing the optical fiber tape unit 26 into the boot 11 for MT connector in the embodiment according to the invention.

(1) The optical fiber cores 21 with an outside diameter of 0.255 mm are exposed by removing the overall coating 27 and the overcoat layer 25 at the tip part of the optical fiber tape unit 26.

(2) The optical fiber tape unit 26 is inserted in the boot 11 for MT connector through an insertion port of the boot entrance part 13.

(3) The optical fiber tape unit 26 is inserted until its removed end (i.e., the front end of the remaining overall coating 27) butts against an entrance of the taper part 14.

(4) The ultraviolet curing resin coating layer 23 is removed, by a heating type stripper, etc., at the tip part of the optical fiber cores 21 with an outside diameter of 0.255 mm projected from the boot 11 for MT connector.

(5) Finally, the boot 11 for MT connector is inserted in the MT connector 30 and fixed thereto with an adhesive.

The boot 11 for MT connector according to the invention can be applied to any MT connectors being fabricated at the factory or at the site.

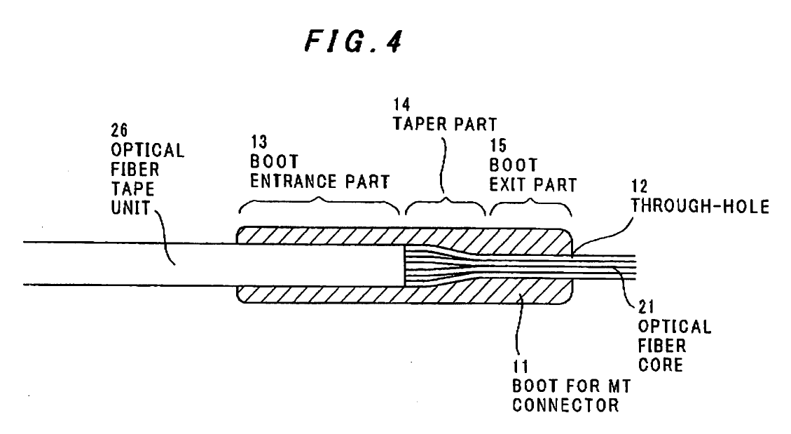

FIG. 4 shows a state of the array pitch conversion at the taper part 14 of the boot 11 for MT connector after the optical fiber tape unit 26 being inserted.

The optical fiber cores 21 which has an outside diameter of 0.255 mm due to the removal of the overcoat layer 25 at the tip part of the optical fiber tape unit 26 is subjected to the array pitch conversion at the taper part 14, whereby the four optical fiber cores 21 are aligned closely into a row at an exit of the taper part 14. Further, they are aligned at the boot exit part 15 with a parallel-walled section of the through-hole 12, and the four optical fiber cores 21 are in alignment projected from the boot 11 for MT connector.

Thus, since the four optical fiber cores 21 are in alignment projected with the core pitch reduced, they can be easily inserted in the MT connector 30 with the standard array pitch as in the case of using the conventional multicore optical fiber tape unit having the optical fiber cores with the core diameter not increased.

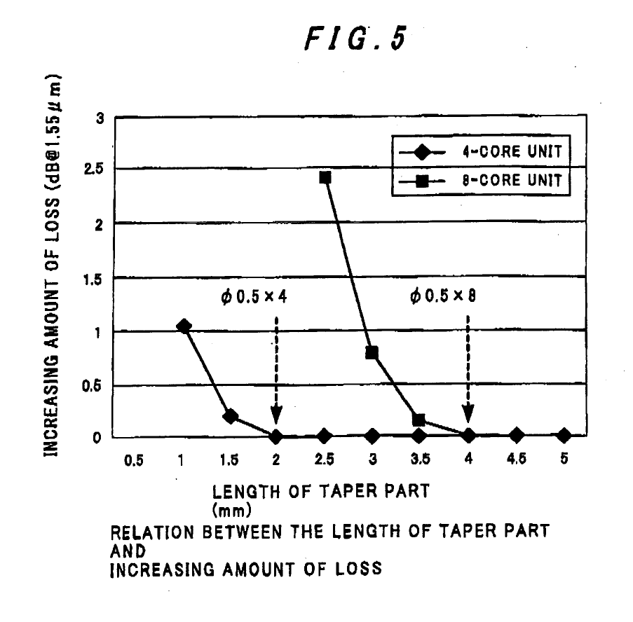

FIG. 5 shows a relation between the length and the bend loss of the taper part.

If the taper part 14 is shortened, the optical fiber core 21 may be subjected to an excessive bend in the process of the conversion of the array pitch at the taper part 14. Thereby, loss due to the bend or disconnection in the optical fiber due to the static fatigue may be generated. In general, the occurrence of the bend loss is more sensitive to the bend than the fiber disconnection due to the static fatigue. Therefore, the relation between the bend loss and the length of the taper part 14 is discussed herein using 4-core and 8-core optical fiber tape units having the optical fiber cores with an outside diameter of 0.5 mm. As shown in FIG. 5, increase in the bend loss is not found when the 4-core optical fiber tape unit has a taper-part length of 2 mm or more and the 8-core optical fiber tape unit is a taper-part length of 4 mm or more.

Thus, it is understood that increase in the bend loss can be prevented when the length of the taper part 14 is not less than the product of <the number of the optical fiber cores bundled in the optical fiber tape unit> and <the outside diameter of the optical fiber core>. Therefore, it is preferable that the length of the taper part 14 is not less than the product of <the number of cores bundled in the optical fiber tape unit> and <the outside diameter of the optical fiber core>.

Also, it is preferable that the plural optical fiber cores 21 are precisely in alignment projected from the boot 11 for MT connector after the conversion of the array pitch. As the result of experiments to confirm the relation between the length of the parallel-walled section at the boot exit part 15 and the alignment precision of the optical fiber cores 21, it is found that the alignment precision can be significantly improved when the parallel-walled section has a length of 2 mm or more. Thus, it is preferred that the parallel-walled section has a length of 2 mm or more.

### EXAMPLE

For example, referring to FIGS. 2A to 2E, a boot for MT connector will be explained below which is used when a 4-core optical fiber tape unit having optical fiber cores with an outside diameter of 0.5 mm is installed into an MT connector with an array pitch of 0.25 mm.

The boot 11 for MT connector is formed of a substantially rectangular solid of 3.2 mm in width, 1.7 mm in height and 16 mm in length. The insertion port for the optical fiber tape unit 26 and the boot entrance part 13 of the through-hole 12 have a rectangular cross section with a width of 2.0 mm and a height of 5.0 mm, and the boot entrance part 13 has a length of 8 mm. The taper part 14 has reduced dimensions in cross section, along the longitudinal direction toward the boot exit part 15, from 2.0 mm and 0.5 mm in width and height, respectively, to 1.0 mm and 0.25 mm in width and height, respectively, and it has a length of 4 mm. The boot exit part 15 has a rectangular cross section of 1.0 mm in width, 0.25 mm in height and 4 mm in length.

The boot for MT connector according to the invention can be applied not only to the 4-core optical fiber tape unit as explained in the above-mentioned embodiment, but also to an 8-core or 12-core or more MT connector.

Further, the boot for MT connector according to the invention can be applied not only to an MT connector with an array pitch of 0.25 mm, but also to an MT connector with a smaller or larger array pitch.

Although the invention has been described with respect to specific embodiment for complete and clear disclosure, the appended claims are not to be thus limited but are to be construed as embodying all modification and alternative constructions that may be occurred to one skilled in the art which fairly fall within the basic teaching herein set forth.

What is claimed is:

1. A boot for an MT connector used for installing a multicore optical fiber tape unit into the MT connector, comprising:
a taper part that converts an array pitch in a plurality of optical fiber cores bundled in the optical fiber tape unit.

2. The boot for the MT connector according to claim 1, wherein:
the taper part comprises a configuration that converts the array pitch from 0.4 mm or more at an entrance of the taper part to 0.25 mm at an exit of the taper part.

3. The boot for the MT connector according to claim 1, wherein:
the taper part has a length not less than the product of <the number of the optical fiber cores> and <an outside diameter of the optical fiber cores>.

4. The boot for the MT connector according to claim 2, wherein:
the taper part has a length not less than the product of <the number of the optical fiber cores> and <an outside diameter of the optical fiber cores>.

5. The boot for the MT connector according to claim 1, further comprising:
a parallel-walled section formed subsequent the taper part,
wherein the parallel-walled section has a length of 2 mm or more so as to allow alignment of the optical fiber cores.

6. The boot for the MT connector according to claim 2, further comprising:
a parallel-walled section formed subsequent the taper part,
wherein the parallel-walled section has a length of 2 mm or more so as to allow alignment of the optical fiber cores.

7. The boot for the MT connector according to claim 3, further comprising:
a parallel-walled section formed subsequent the taper part,
wherein the parallel-walled section has a length of 2 mm or more so as to allow alignment of the optical fiber cores.

8. The boot for the MT connector according to claim 4, further comprising:
a parallel-walled section formed subsequent the taper part,
wherein the parallel-walled section has a length of 2 mm or more so as to allow alignment of the optical fiber cores.
